(19) United States
(12) Patent Application Publication
(10) Pub. No.: US 2009/0230716 A1
(43) Pub. Date: Sep. 17, 2009

(54) SUN VISOR FOR VEHICLE-MOUNTED EQUIPMENT

(75) Inventor: Young-Hun CHAE, Daegu-si (KR)

Correspondence Address: CANTOR COLBURN, LLP, 20 Church Street, 22nd Floor, Hartford, CT, 06103, US

(73) Assignee: ISTT CO. LTD, Daegu-si (KR)

(21) Appl. No.: 12/355,287

(22) Filed: Jan. 16, 2009

(30) Foreign Application Priority Data
Mar. 12, 2008 (KR) 10-2008-0022771
Aug. 26, 2008 (KR) 10-2008-0083451

(51) Int. Cl. B60J 3/00

(52) U.S. Cl. 296/97.9

(57) ABSTRACT

A sun visor for vehicle-mounted equipment that blocks light incident on a screen of various vehicle-mounted equipment mounted inside a vehicle is provided. The sun visor for vehicle-mounted equipment includes a visor member blocking light incident on the screen of the vehicle-mounted equipment mounted inside the vehicle, and a fixing wire detachably fixing the visor member to the vehicle-mounted equipment and elastically biased against the vehicle-mounted equipment. Accordingly, attachment to vehicle-mounted equipment is possible regardless of the shape of the vehicle-mounted equipment.

### CROSS REFERENCE TO RELATED APPLICATIONS

This application claims priority from Korean Patent Applications No. 10-2008-0022771, filed on Mar. 12, 2008, and No. 10-2008-0083451, filed on Aug. 26, 2008, the disclosures of which are incorporated herein in their entireties by reference.

### BACKGROUND OF THE INVENTION

1. Field of the Invention

The present invention relates to a sun visor, and more particularly, to a sun visor for vehicle-mounted equipment that blocks light incident on a screen of various vehicle-mounted equipment mounted inside a vehicle.

2. Description of the Related Art

Recently, vehicle-mounted equipment mounted inside vehicles and providing various functions to passengers is widely used. For example, equipment having a navigation function or equipment combining a navigation function and a digital multimedia broadcasting (DMB) receiving function is often mounted inside vehicles. The navigation function enables easy guiding of a driver to a desired destination and is a big help when driving. Also, the DMB receiving function enables passengers to watch and listen to various multimedia broadcasts while the vehicle is in motion and is widely used together with the navigation function.

Such vehicle-mounted equipment is usually installed at a center part in front of the front seat so that passengers can conveniently view a navigation map or broadcasting. A sun visor is detachably combined with vehicle-mounted equipment and functions to block light incident on a screen of the vehicle-mounted equipment from outside.

A conventional sun visor is equipped with a visor member and a fixing clip. The visor member is formed to wrap around the screen of the vehicle-mounted equipment such that light from outside is not incident. The fixing clip is combined with one side of the visor member and formed to apply pressure to the backside of the vehicle-mounted equipment.

General vehicle-mounted equipment is not made by just one manufacturer and thus can be produced in various forms. When attaching a sun visor to such vehicle-mounted equipment, if the backside of the vehicle-mounted equipment is flat, it is easy to fix the visor member of the conventional sun visor to the vehicle-mounted equipment using the fixing clip. However, when the backside of the vehicle-mounted equipment is not a flat surface, for example, when it is a to curved surface, a gap is created between the backside of the vehicle-mounted equipment and the fixing clip and the sun visor is not securely fixed to the vehicle-mounted equipment.

### SUMMARY OF THE INVENTION

The present invention provides a sun visor for vehicle-mounted equipment that is easy to attach regardless of the shape of the vehicle-mounted equipment.

Additional aspects of the invention will be set forth in the description which follows, and in part will be apparent from the description, or may be learned by practice of the invention.

The present invention discloses a sun visor for vehicle-mounted equipment including a visor member blocking light incident on a screen of vehicle-mounted equipment mounted inside a vehicle, and a fixing wire detachably fixing the visor member to the vehicle-mounted equipment and elastically biased against the vehicle-mounted equipment.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a perspective view of a sun visor according to one exemplary embodiment of the present invention attached to vehicle-mounted equipment.

FIG. 2 is an exploded perspective view of a sun visor according to one exemplary embodiment of the present invention.

FIG. 3 is a schematic side view of a sun visor according to one exemplary embodiment of the present invention attached to vehicle-mounted equipment.

FIG. 4 is an exploded perspective view of a sun visor according to one exemplary embodiment of the present invention.

FIG. 5 is a side view of a sun visor according to the exemplary embodiment of the present invention shown in FIG. 4 attached to vehicle-mounted equipment.

FIG. 6 is an exploded perspective view of a sun visor according to another exemplary embodiment of the present invention.

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

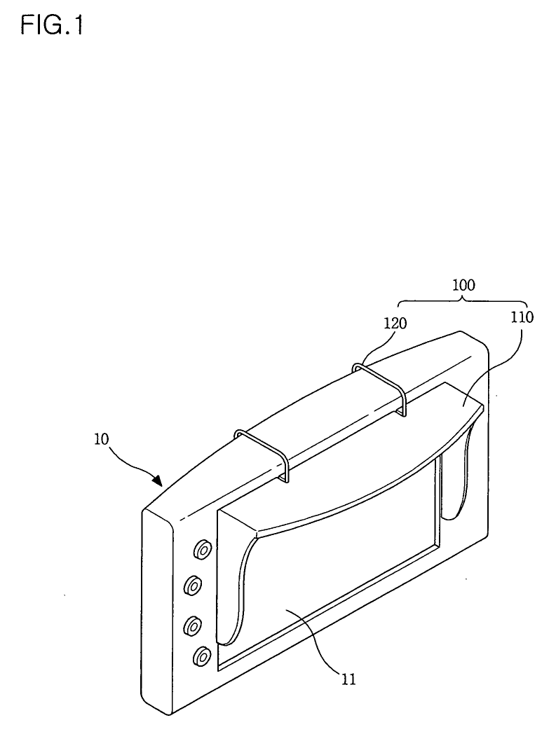

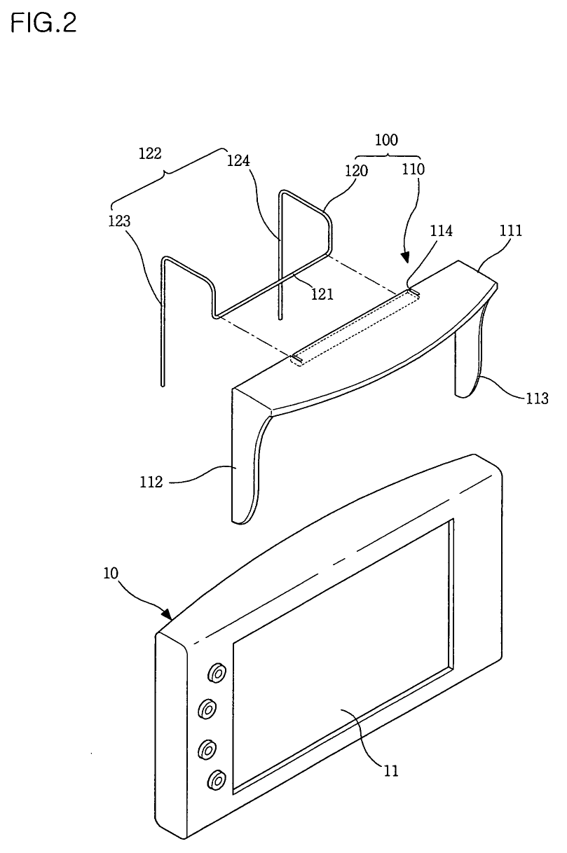

FIG. 1 is a perspective view of a sun visor according to one exemplary embodiment of the present invention attached to vehicle-mounted equipment, and FIG. 2 is an exploded perspective view of a sun visor according to one exemplary embodiment of the present invention.

Referring to FIGS. 1 and 2, a sun visor 100 for vehicle-mounted equipment according to one exemplary embodiment of the present invention includes a visor member 110 and a fixing wire 120.

The visor member 110 is arranged at the front of a screen 11 of vehicle-mounted equipment 10, and is formed to block light incident on the screen. The visor member 110 is preferably made of a material that does not transmit light. Even if light entering the vehicle is incident on the screen side of the vehicle-mounted equipment, the visor member 110 blocks the light so that the visibility of the screen can be improved. Thus, a user can clearly see an image displayed on the screen 11 of the vehicle-mounted equipment 10.

The fixing wire 120 detachably fixes the visor member 110 to the vehicle-mounted equipment 10. One side of the fixing wire 120 is combined with the visor member 110. In a state in which the visor member 110 is disposed at the front of the vehicle-mounted equipment, the fixing wire 120 applies elastic force to the vehicle-mounted equipment 10 and prevents the visor member 110 from detaching from the vehicle-mounted equipment 10.

When a conventional sun visor is attached to vehicle-mounted equipment, if the backside of the vehicle-mounted equipment is not a flat surface, the fixing clip does not adhere closely to the backside of the vehicle-mounted equipment and a gap is created so the sun visor is not securely fixed to the vehicle-mounted equipment.

However, in the sun visor 100 according to the present invention, since the visor member 110 is fixed to the vehicle-mounted equipment by the fixing wire 120, no matter whether the shape of the vehicle-mounted equipment is formed to be flat, curved, or something else, the visor member 110 and the vehicle-mounted equipment 10 can be firmly combined.

Describing the structure of the fixing wire 120 in detail, the fixing wire 120 may include a fixing part 121 and an elastic part 122.

The fixing part 121 is inserted into and combined with one side of the visor member 110.

The elastic part 122 extends from the fixing part 121 and elastically supports the backside of the vehicle-mounted equipment 110. The elastic part 122 functions to fix the visor member 110 to the vehicle-mounted equipment 10 by elastic force. The elastic part 122 may be integrally formed with the fixing part 121. This enables manufacturing cost to be reduced since it is not necessary to make the fixing part 121 and the elastic part 122 separately and then assemble them.

A fixing groove 114 is formed in the visor member 110 so that the fixing wire 120 having the above structure can be combined with the visor member 110. When the fixing wire 120 is combined with the upper side of the visor member 110 as shown in FIG. 2, the fixing groove 114 can be formed in the upper side of the visor member 110 to correspond to the fixing wire 120. The fixing groove 114 opens toward the rear and the fixing wire 120 is combined from the rear toward the front.

As one example of the detailed structure of the elastic part 122, the elastic part 122 is integrally formed with the fixing part 121 and includes a first elastic support part 123 and a second elastic support part 124.

The first elastic support part 123 extends from one end of the fixing part 121 and applies elastic force to the left side of the backside of the vehicle-mounted equipment.

The second elastic support part 124 extends from the other end of the fixing part 121 and applies elastic force to the right side of the backside of the vehicle-mounted equipment.

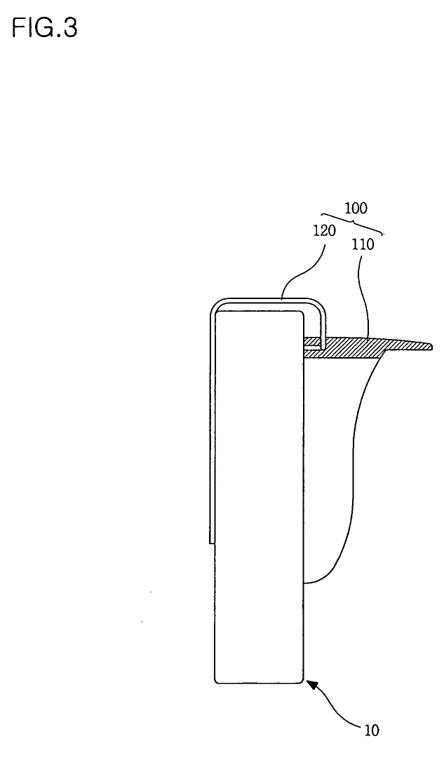

The first and second elastic support parts 123 and 124 may have a structure formed as a bent extension of the fixing part 121. In a state in which the fixing part 121 is combined with the visor member 110, as shown in FIG. 3, the first and second elastic support parts 123 and 124 are bent enough so that they can pass over the top of the vehicle-mounted equipment and apply pressure to the backside of the vehicle-mounted equipment through elastic force. Accordingly, the visor member 110 can be fixed in close contact with the vehicle-mounted equipment 10.

A user combines the fixing part 121 of the fixing wire 120 with the fixing groove 114 of the visor member 110, and arranges the visor member 110 at the front of the vehicle-mounted equipment. Also, if the fixing wire 120 is made to elastically support the backside of the vehicle-mounted equipment, the visor member 110 can be easily attached to the vehicle-mounted equipment 10.

That is, since the above-described combined structure of the fixing wire 120 and the visor member 110 is a simple structure, it is possible to reduce the time required to manufacture the sun visor 100. In addition, a user can easily combine the visor member 110 and the fixing wire 120.

Also, in a state in which the visor member 110 is fixed to the vehicle-mounted equipment 10, if a user only removes the fixing wire 120 from the vehicle-mounted equipment 10, the visor member 110 can be easily separated from the vehicle-mounted equipment 10.

Meanwhile, referring back to FIG. 2, one example of the visor member 110 described above includes an upper visor panel 111, a left visor panel 112, and a right visor panel 113.

The upper visor panel 111 is shaped like a plate and disposed at the upper perimeter of the screen, perpendicular to the screen, to block light incident from above the screen. While the upper visor panel 111 may be formed in a shape having a fixed width, it may also be formed in a shape in which its thickness decreases from center toward left and right ends, as shown in the drawings.

The left visor panel 112 is formed in the shape of a plate bent downward from the left end of the upper visor panel 111. Accordingly, the left visor panel 112 is disposed at the left perimeter of the screen, perpendicular to the screen, and can block light incident from the left side of the screen.

The right visor panel 113 is formed in the shape of a plate bent downward from the left end of the upper visor panel 111. Accordingly, the right visor panel 113 is disposed at the right perimeter of the screen, perpendicular to the screen, and can block light incident from the right side of the screen.

The vertical lengths of the left and right visor panels 112 and 113 may be shorter than the vertical length of the screen. However, they are preferably set to be the same as or longer than the vertical length of the screen so as to ensure that light is sufficiently blocked.

Also, the left and right visor panels 112 and 113 each may be formed in a shape having a fixed width. However, they may also be formed in a shape whose width decreases in the downward direction, as shown in the drawings.

Meanwhile, the sun visor 100 of the present invention may further include a rotation prevention means.

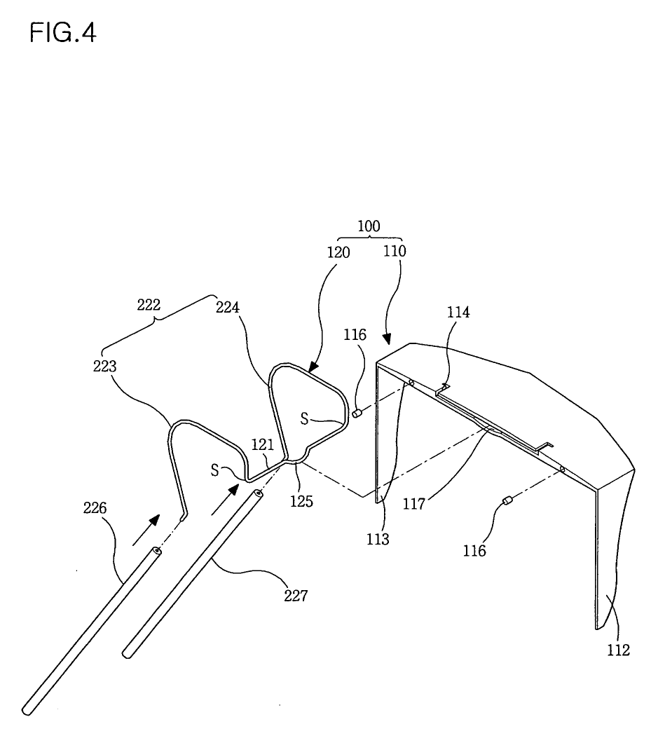

As shown in FIG. 4, the rotation prevention means includes a rotation prevention part 125 and a rotation prevention groove 117.

The rotation prevention part 125 is formed by a bent part of the portion of the fixing part 121 that is inserted into the visor member 110. In FIG. 4, the rotation prevention part 125 is drawn as being bent downward, however it is not limited to this configuration and can also be bent upward.

The rotation prevention groove 117 is formed in the backside of the visor member 100 to be indented toward the front and has a shape corresponding to the rotation prevention part 125. That is, if the rotation prevention part 125 is formed in a downwardly bent shape, the rotation prevention groove 117 is also preferably formed in a downwardly bent indented shape that is the same as the rotation prevention part 125.

In the rotation prevention means having such a structure when the fixing wire 120 and the visor member 110 are combined and attached to the vehicle-mounted equipment 10 (refer to FIG. 3), the rotation prevention part 125 is received in the rotation prevention groove 117 and the fixing wire 120 can be prevented from rotating or shifting with respect to the visor member 110.

Meanwhile, while the rotation prevention part 125 is drawn in FIG. 4 as though only one was formed, it is not limited to this configuration and it is also possible for a plurality of rotation prevention parts to be formed. In such a structure, the rotation prevention part 125 and the to rotation prevention groove 117 are more securely joined to one another, and even if the size of the visor member 110 increases in proportion to increase in the size of the screen 11 (refer to FIG. 2) of the vehicle-mounted equipment 10 (refer to FIG. 2), the visor member 110 can be securely fastened to the vehicle-mounted equipment 10 (refer to FIG. 2).

When there are a plurality of rotation prevention parts 125 like this, it is preferable that a plurality of rotation prevention grooves 117 are formed too, or that one long rotation prevention groove 117 is formed along the length of the fixing part 125, so that the plurality of rotation prevention parts 125 can be received therein.

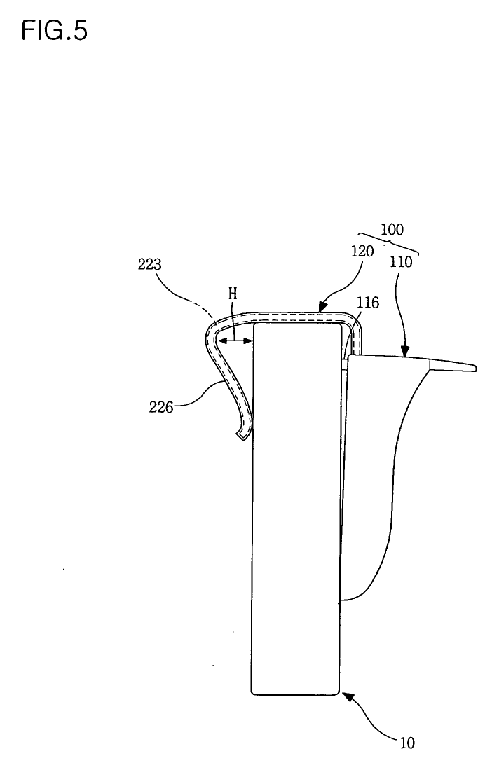

Meanwhile, as shown in FIG. 5, a first elastic support part 223 and a second elastic support part 224 according to another exemplary embodiment can be formed to maintain a fixed gap H with the backside of the vehicle-mounted equipment 10. In such a structure, when attaching the sun visor 100 to vehicle-mounted equipment, the first elastic support part 223 and the second elastic support part 224 have resistance to deforming stress and can continue to supply elastic force for a long period of time.

Also, the elastic part 222 may further be equipped with protective tubes 226 and 227. The protective tubes 226 and 227 are formed in the shape of hollow tubes and fit onto both ends of the fixing part 121 (refer to FIG. 4) from the ends of the first elastic support part 223 and the second elastic support part 224 up to a meeting point S with the first elastic support part 223 (refer to FIG. 4) or the second elastic support part 224 (refer to FIG. 4). In a state in which the sun visor 100 is combined with the vehicle-mounted equipment 10, the protective tubes 226 and 227 not only prevent the fixing wire 120 from scratching the vehicle-mounted equipment 10 but also play the role of preventing the fixing wire 120 from detaching from the vehicle-mounted equipment 10. To this end, the protective tubes 226 and 227 may be formed of rubber or silicone, etc. However, the protective tubes 226 and 227 are not limited to these materials, and any material can be used as long as it does not scratch the vehicle-mounted equipment 10 and has high friction.

Also, the visor member 110 may further be provided with a fixing protrusion 116. The fixing protrusion 116 is combined with the backside of the visor member 110. A hole is formed in the backside of the visor member 110 and the fixing protrusion 116 can be inserted into the hole. In a state in which the sun visor 100 according to the present invention is attached to the vehicle-mounted equipment 10, the fixing protrusion 116 combines the visor member 110 with the vehicle-mounted equipment 10 by strong friction so that the visor member 110 does not move from the vehicle-mounted equipment 10 due to external force. To this end, the fixing protrusion 116 may be formed of high-friction rubber or silicone, etc.

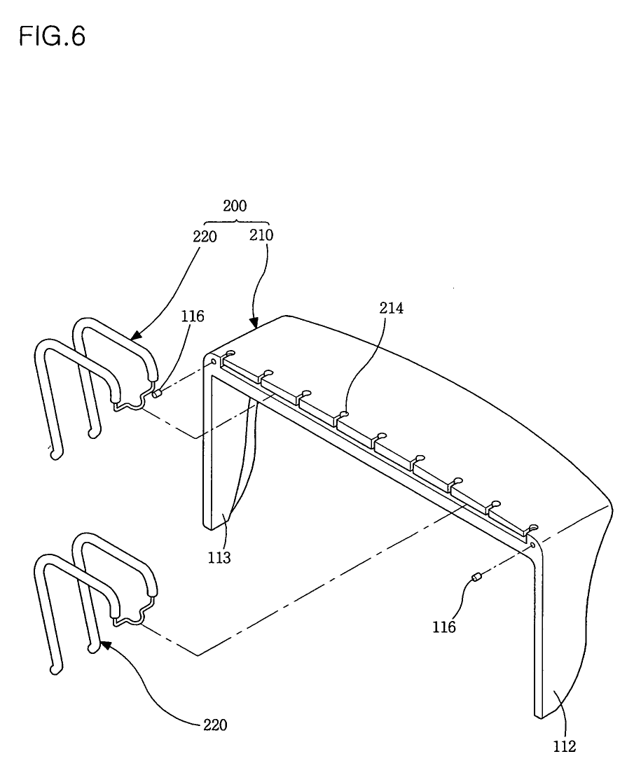

FIG. 6 is an exploded perspective view of a sun visor according to another exemplary embodiment of the present invention.

Referring to FIG. 6, a sun visor 200 according to another exemplary embodiment of the present invention includes a plurality of fixing wires 220. Also, a plurality of pairs of the fixing grooves 214 are formed in an upper portion of the visor member and enable the fixing wires 220 to be combined.

When the sun visor 200 of the present invention is attached to vehicle-mounted equipment 10 (refer to FIG. 2) having various sizes of screens 11 (refer to FIG. 2), the above structure enables the visor member 210 to not detach from the vehicle-mounted equipment 10 (refer to FIG. 2) and firmly combine therewith. For example, the size of the screen 11 (refer to FIG. 2) of the vehicle-mounted equipment 10 (refer to FIG. 2) is 4.3 inches, 7 inches, or various larger sizes. As the screen 11 (refer to FIG. 2) of the vehicle-mounted equipment 10 (refer to FIG. 10) increases in size, two, three or more fixing wires 220 are combined with fixing grooves 214 of the visor member 210 as shown in the drawing so that the visor member 210 is strongly fixed to the vehicle-mounted equipment 10 (refer to FIG. 10).

As is apparent from the above description, attachment to vehicle-mounted equipment is possible regardless of the shape of the vehicle-mounted equipment.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A sun visor for vehicle-mounted equipment, comprising:
a visor member for blocking light incident on a screen of vehicle-mounted equipment mounted inside a vehicle; and
a fixing wire for detachably fixing the visor member to the vehicle-mounted equipment and elastically biased against the vehicle-mounted equipment.

2. The sun visor for vehicle-mounted equipment according to claim 1, wherein the fixing wire comprises:
a fixing part inserted into and combined with one side of the visor member; and
an elastic part extending from the fixing part to elastically support the backside of the vehicle-mounted equipment, and
wherein a fixing groove into which the fixing part is inserted is formed in an upper portion of the visor member.

3. The sun visor for vehicle-mounted equipment according to claim 2, wherein the elastic part is integrally formed with the fixing part and comprises:
a first elastic support part extending from one end of the fixing part and elastically biased against the vehicle-mounted equipment; and
a second elastic support part extending from the other end of the fixing part and elastically biased against the vehicle-mounted equipment.

4. The sun visor for vehicle-mounted equipment according to claim 2, further comprising a rotation prevention means equipped with a rotation prevention part formed by a bent part of a portion of the fixing part that is inserted into the visor member, and a rotation prevention groove formed in the backside of the visor member to be indented toward the front and having a shape corresponding to the rotation prevention part.

5. The sun visor for vehicle-mounted equipment according to claim 1, wherein a plurality of pairs of fixing grooves are formed in an upper portion of the visor member, and the plurality of fixing wires are inserted into the fixing grooves.
